(19) United States
(12) Patent Application Publication
(10) Pub. No.: US 2023/0324726 A1
(43) Pub. Date: Oct. 12, 2023

(54) OPTICAL DEVICE, OPTICAL MODULATOR, AND OPTICAL COMMUNICATION APPARATUS

(71) Applicant: Fujitsu Optical Components Limited, Kawasaki-shi (JP)

(72) Inventor: Masaki SUGIYAMA, Kawasaki (JP)

(73) Assignee: Fujitsu Optical Components Limited, Kawasaki-shi (JP)

(21) Appl. No.: 18/085,995

(22) Filed: Dec. 21, 2022

(30) Foreign Application Priority Data
Mar. 23, 2022 (JP) 2022-047061

(51) Int. Cl. G02F 1/065

(52) U.S. Cl. CPC G02F 1/065

(57) ABSTRACT

A device includes a waveguide, an electrode that has a coplanar structure, and an interaction unit that is constituted such that the interaction unit is inserted into a slot of the waveguide, that is formed using an electro-optical polymer, and that acts on light passing through the waveguide according to a voltage received from the electrode. The device includes an excessive length unit that extends to an input side and an output side of the interaction unit and that is formed using the electro-optical polymer, and an other waveguide that is not connected to the waveguide and that is formed by inserting the excessive length unit into the slot located between a first doped layer that is connected to a ground electrode disposed parallel to the excessive length unit and a second doped layer that is connected to a signal electrode disposed parallel to the excessive length unit.

### CROSS-REFERENCE TO RELATED APPLICATION

This application is based upon and claims the benefit of priority of the prior Japanese Patent Application No. 2022-047061, filed on Mar. 23, 2022, the entire contents of which are incorporated herein by reference.

### FIELD

The embodiments discussed herein are related to an optical device, an optical modulator, and an optical communication apparatus.

### BACKGROUND

FIG. 17 is a schematic plan view illustrating an example of an optical modulator 100 that is conventionally used. The optical modulator 100 illustrated in FIG. 17 includes an optical waveguide 101, and an electrode 102 that has a coplanar waveguide (CPW) structure including a signal electrode and a ground electrode. The optical waveguide 101 is a PN junction optical waveguide constituted of an N doped silicon layer 105A (105) (hereinafter, simply referred to as a doped Si layer) and a P doped Si layer 105B (105). The optical waveguide 101 includes an input portion 101A, a branching portion 101B, two waveguides 101C, a multiplexing portion 101D, and an output portion 101E. The input portion 101A is an input portion of the optical modulator 100 that inputs light to the optical modulator 100. The branching portion 101B optically branches the light received from the input portion 101A, and outputs the branched light to the two waveguides 101C. Each of the two waveguides 101C is an arm of the optical modulator 100 that guides the light received from the branching portion 101B and that acts on the propagating light in accordance with an electric field between the electrodes 102. The multiplexing portion 101D multiplexes that light received from the two waveguides 101C, and outputs the multiplexed light. The output portion 101E is an output portion of the optical modulator 100 that outputs the light received from the multiplexing portion 101D.

The electrode 102 is an electrode that has a coplanar structure and that includes a first ground electrode 102A1, a first signal electrode 102B1, a second ground electrode 102A2, a second signal electrode 102B2, and a third ground electrode 102A3.

The first signal electrode 102B1 is disposed between the first ground electrode 102A1 and the second ground electrode 102A2 so as to be parallel thereto. The second signal electrode 102B2 is disposed between the second ground electrode 102A2 and the third ground electrode 102A3 so as to be parallel thereto.

Between the two waveguides 101C, a first waveguide 101C1 is an optical waveguide that is disposed at a lower part of a region located between the first ground electrode 102A1 and the first signal electrode 102B1. Between the two waveguides 101C, a second waveguide 101C2 is an optical waveguide that is disposed at a lower part of a region located between the second signal electrode 102B2 and the third ground electrode 102A3.

In the case where the optical modulator 100 performs high-speed modulation, a drive voltage of a high frequency signal having a band of, for example, a several tens of gigahertz (GHz) is input to the first and the second signal electrodes 102B1 and 102B2, respectively, that are disposed along the waveguide 101C.

FIG. 18 is a schematic cross-sectional diagram taken along line G-G illustrated in FIG. 17. The arm on the first waveguide 101C1 side illustrated in FIG. 18 includes a silicon substrate 131, an intermediate layer 132 that is made of SiO₂ and that is laminated on the silicon substrate 131, and the first waveguide 101C1 that is formed on the intermediate layer 132. Furthermore, the arm on the first waveguide 101C1 side includes a buffer layer 133 that is made of SiO₂ and that is laminated on the intermediate layer 132 including the first waveguide 101C1, and the electrode 102. In addition, the electrode 102 includes the first ground electrode 102A1, the first signal electrode 102B1, and the second ground electrode 102A2.

The buffer layer 133 on the first waveguide 101C1 side includes a via layer 106A1 (106) that electrically connects a portion between the first ground electrode 102A1 and the N doped Si layer 105A that is included in the first waveguide 101C1. Furthermore, the buffer layer 133 includes a via layer 106A2 (106) that electrically connects a portion between the first signal electrode 102B1 and the P doped Si layer 105B that is included in the first waveguide 101C1.

Furthermore, although not illustrated, an arm on the second waveguide 101C2 side includes the silicon substrate 131, the intermediate layer 132 made of SiO₂, and the second waveguide 101C2. Furthermore, the arm on the second waveguide 101C2 side includes the buffer layer 133 made of SiO₂ and the electrode 102. In addition, the electrode 102 includes the second ground electrode 102A2, the second signal electrode 102B2, and the third ground electrode 102A3.

The buffer layer 133 on the second waveguide 101C2 side includes the via layer 106A1 that electrically connects a portion between the third ground electrode 102A3 and the N doped Si layer 105A in the second waveguide 101C2. Furthermore, the buffer layer 133 on the second waveguide 101C2 side includes the via layer 106A2 that electrically connects a portion between the second signal electrode 102B2 and the P doped Si layer 105B in the second waveguide 101C2.

In the optical modulator 100, if a drive voltage of a high-frequency signal is applied to the first signal electrode 102B1, a carrier density of the PN junction of the first waveguide 101C1 between the first signal electrode 102B1 and the first ground electrode 102A1 is changed. In the optical modulator 100, the phase of light propagating through the first waveguide 101C is changed as a result of a change in the refractive index of the first waveguide 101C1 in accordance with a change in the carrier density. Similarly, in the optical modulator 100, if a drive voltage of a high-frequency signal is applied to the second signal electrode 102B2, a carrier density of the PN junction of the second waveguide 101C2 between the second signal electrode 102B2 and the third ground electrode 102A3 is changed. In the optical modulator 100, the phase of the light propagating through the second waveguide 101C2 is changed as a result of a change in the refractive index of the second waveguide 101C2 in accordance with a change in the carrier density. Consequently, in the multiplexing portion 101D, by multiplexing the light that has been received from the first waveguide 101C1 and that has been subjected to phase modulation and the light that has been received from the second waveguide 101C2 and that has been subjected to phase modulation, the optical modulator 100 is able to perform conversion, such as a change in light intensity at multilevel in accordance with a phase difference of the light.

Patent Document 1: Japanese Laid-open Patent Publication No. 2021-026090
Patent Document 2: Japanese Laid-open Patent Publication No. 2021-015186
Patent Document 3: U.S. Patent No. 6711308
Patent Document 4: Japanese Laid-open Patent Publication No. 8-054652
Patent Document 5: U.S. Patent Application Publication No. 2009/0269017

However, the optical waveguide 101 included in the conventional optical modulator 100 is constituted of a silicon PN junction, so that a change in the refractive index of light is small, and the drive voltage of the high-frequency signal applied to the first signal electrode 102B1 and the second signal electrode 102B2 is large, so that electric power consumption is increased.

### SUMMARY

According to an aspect of an embodiment, an optical device includes a waveguide, an electrode, an interaction unit, an excessive length unit and an other waveguide. The electrode has a coplanar structure and includes a signal electrode and a ground electrode that are disposed parallel to the waveguide. The interaction unit is constituted such that a part of the interaction unit is inserted into a slot provided in the waveguide. The interaction unit is formed using an electro-optical polymer, and acts on light passing through the waveguide in accordance with a drive voltage of a high-frequency signal received from the electrode. The excessive length unit extends to an input side and an output side of the interaction unit and is formed using the electro-optical polymer. The other waveguide is not connected to the waveguide and is formed by inserting a part of the excessive length unit into the slot located between a first doped layer that is connected to the ground electrode that is disposed parallel to the excessive length unit and a second doped layer that is connected to the signal electrode that is disposed parallel to the excessive length unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a present embodiment;

FIG. 2 is a schematic plan view illustrating a configuration of an optical modulator according to a first embodiment;

FIG. 3 is a schematic plan view in which a drawing of an EO polymer included in the optical modulator illustrated in FIG. 2 has been omitted;

FIG. 4 is a schematic cross-sectional diagram of a first region illustrated in FIG. 2 taken along line A-A;

FIG. 5 is a schematic cross-sectional diagram of a second region illustrated in FIG. 2 taken along line B-B;

FIG. 6 is a schematic cross-sectional diagram of a third region illustrated in FIG. 2 taken along line C-C;

FIG. 7 is a schematic cross-sectional diagram of a fourth region illustrated in FIG. 2 taken along line D-D;

FIG. 8 is a schematic cross-sectional diagram illustrating a first region included in an optical modulator according to a second embodiment taken along line A-A;

FIG. 9 is a schematic cross-sectional diagram illustrating a first region included in an optical modulator according to a third embodiment taken along line A-A;

FIG. 10 is a schematic cross-sectional diagram illustrating a third region included in an optical modulator according to a fourth embodiment taken along line C-C;

FIG. 11 is a schematic plan view in which a drawing of an EO polymer included in a third region included in the optical modulator according to the fourth embodiment has been omitted;

FIG. 12 is a schematic cross-sectional diagram illustrating a third region included in an optical modulator according to a fifth embodiment taken along line C-C;

FIG. 13 is a schematic plan view illustrating an example of a configuration of an optical modulator according to a comparative example;

FIG. 14 is a schematic plan view in which a drawing of an EO polymer included in the optical modulator illustrated in FIG. 13 has been omitted;

FIG. 15 is a schematic cross-sectional diagram of a first region illustrated in FIG. 13 taken along line E-E;

FIG. 16 is a schematic cross-sectional diagram of a second region illustrated in FIG. 13 taken along line F-F;

FIG. 17 is a schematic plan view illustrating an example of a configuration of a conventional optical modulator; and

FIG. 18 is a schematic cross-sectional diagram taken along line G-G illustrated in FIG. 17.

### DESCRIPTION OF EMBODIMENTS

### Comparative Example

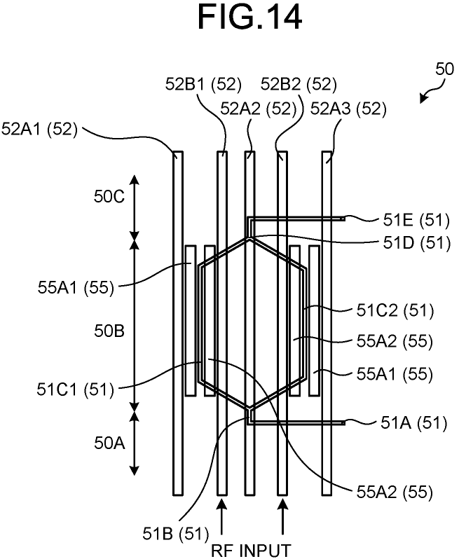

In an optical modulator, it is conceivable to use an optical waveguide provided with an EO polymer instead of an optical waveguide made of silicon using a PN junction in order to suppress a drive voltage of a high-frequency signal applied to a first signal electrode and a second signal electrode. FIG. 13 is a schematic plan view illustrating an example of a configuration of an optical modulator 50 according to a comparative example, and FIG. 14 is a schematic plan view in which a drawing of the EO polymer provided in the optical modulator 50 illustrated in FIG. 13 has been omitted.

The optical modulator 50 according to the comparative example illustrated in FIG. 13 includes an optical waveguide 51, and an electrode 52 that has a coplanar structure and that includes a signal electrode and a ground electrode. The optical waveguide 51 is a slot waveguide constituted from two N doped Si layers 55A (55). The optical waveguide 51 includes an input portion 51A, a branching portion 51B, two waveguides 51C, a multiplexing portion 51D, and an output portion 51E. The input portion 51A is an input portion of the optical modulator 50 that inputs light to the optical modulator 50. The branching portion 51B optically branches the light received from the input portion 51A and outputs the branched light to the two waveguides 51C. Each of the two waveguides 51C is an arm of the optical modulator 50 that guides the light received from the branching portion 51B and that acts on the light propagating in accordance with an electric field between the electrodes 52. The multiplexing portion 51D multiplexes the branched light received from the two waveguides 51C and outputs the multiplexed light. The output portion 51E is an output portion of the optical modulator 50 that outputs the light received from the multiplexing portion 51D.

The electrode 52 is an electrode that has a coplanar structure and that includes a first ground electrode 52A1, a first signal electrode 52B1, a second ground electrode 52A2, a second signal electrode 52B2, and a third ground electrode 52A3. The first signal electrode 52B1 is disposed between the first ground electrode 52A1 and the second ground electrode 52A2 so as to be parallel thereto. The second signal electrode 52B2 is disposed between the second ground electrode 52A2 and the third ground electrode 52A3 so as to be parallel thereto.

Between the two waveguides 51C, a first waveguide 51C1 is an optical waveguide that is disposed at a lower part of a region located between the first ground electrode 52A1 and the first signal electrode 52B1. The first waveguide 51C1 is a slot waveguide provided with a slot constituted of the two N doped Si layers 55A. An EO polymer 53 located on the first waveguide 51C1 side includes an input side excessive length unit 53A, an interaction unit 53B, and an output side excessive length unit 53C. The interaction unit 53B is constituted such that a part of the interaction unit 53B is inserted into the slot included in the first waveguide 51C1 and is an EO polymer that acts on light passing through the first waveguide 51C1 in accordance with a drive voltage of a high-frequency signal applied from the first signal electrode 52B1 to the first ground electrode 52A1. The input side excessive length unit 53A is an EO polymer extending on the input side of the interaction unit 53B. The output side excessive length unit 53C is an EO polymer extending on the output side of the interaction unit 53B. Each of the input side excessive length unit 53A and the output side excessive length unit 53C is a region in which the optical waveguide 51 is not present. The interaction unit 53B forms the first waveguide 51C1 as a result of a part of the interaction unit 53B being injected into a slot located between an N doped Si layer 55A1 (55) and an N doped Si layer 55A2 (55).

Between the two waveguides 51C, a second waveguide 51C2 is an optical waveguide that is disposed at a lower part of a region located between the second signal electrode 52B2 and the third ground electrode 52A3. The second waveguide 51C2 is a slot waveguide provided with a slot that is constituted of the two N doped Si layers 55A. The EO polymer 53 located on the second waveguide 51C2 side includes the input side excessive length unit 53A, the interaction unit 53B, and the output side excessive length unit 53C. The interaction unit 53B is constituted such that a part of the interaction unit 53B is inserted into the slot included in the second waveguide 51C2 and is an EO polymer that acts on light passing through the second waveguide 51C2 in accordance with a drive voltage of a high-frequency signal applied from the second signal electrode 52B2 to the third ground electrode 52A3. The input side excessive length unit 53A is an EO polymer extending on the input side of the interaction unit 53B. The output side excessive length unit 53C is an EO polymer extending on the output side of the interaction unit 53B. A region in which each of the input side excessive length unit 53A and the output side excessive length unit 53C is a region in which the optical waveguide 51 is not present. The interaction unit 53B forms the second waveguide 51C2 as a result of a part of the interaction unit 53B being injected into the slot located between the N doped Si layer 55A1 and the N doped Si layer 55A2.

The optical modulator 50 includes a first region 50A, a second region 50B, and a third region 50C. It is assumed that the optical modulator 50 is disposed in the order of the first region 50A, the second region 50B, and the third region 50C in a travelling direction of light passing from an input toward an output.

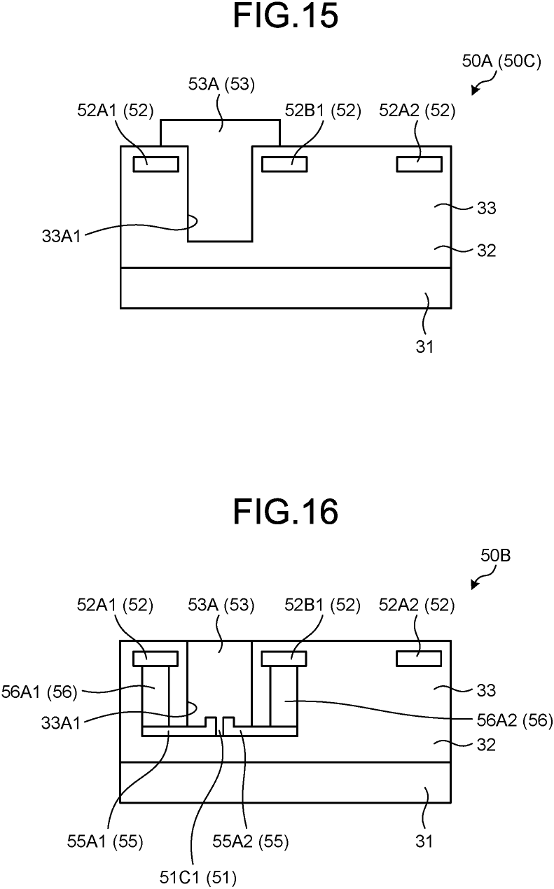

FIG. 15 is a schematic cross-sectional diagram of the first region 50A illustrated in FIG. 13 taken along line E-E. The first region 50A illustrated in FIG. 15 is a region of the optical modulator 50 in which the input side excessive length unit 53A formed using the EO polymer 53 is disposed. The first region 50A on the first waveguide 51C1 side includes a silicon substrate 31, an intermediate layer 32 that is made of SiO₂ and that is laminated on the silicon substrate 31, and the first waveguide 51C1 that is formed on the intermediate layer 32. The first region 50A on the first waveguide 51C1 side includes a buffer layer 33 that is made of SiO₂ and that is laminated on the intermediate layer 32 including the first waveguide 51C1, and the electrode 52. Furthermore, the electrode 52 includes the first ground electrode 52A1, the first signal electrode 52B1, and the second ground electrode 52A2. The first region 50A on the first waveguide 51C1 side includes an opening portion 33A1 that is formed in the buffer layer 33 located between the first ground electrode 52A1 and the first signal electrode 52B1, and the input side excessive length unit 53A that is the EO polymer 53 that is injected into the opening portion 33A1. Therefore, the EO polymer 53 consequently forms the input side excessive length unit 53A as a result of being injected into the opening portion 33A1 by using, for example, a dispenser.

The first region 50A on the second waveguide 51C2 side includes the silicon substrate 31, the intermediate layer 32 that is made of SiO₂ and that is laminated on the silicon substrate 31, the buffer layer 33 that is made of SiO₂ and that is laminated on the intermediate layer 32, and an electrode 12. Furthermore, the electrode 12 includes a second ground electrode 12A2, a second signal electrode 12B2, and a third ground electrode 12A3. A first region 20A on the second waveguide 51C2 side includes the opening portion 33A1 that is formed in the buffer layer 33 located between the third ground electrode 12A3 and the second signal electrode 12B2, and the input side excessive length unit 53A that is the EO polymer 53 injected into the opening portion 33A1. Therefore, the EO polymer 53 consequently forms the input side excessive length unit 53A as a result of being injected into the opening portion 33A1 by using, for example, a dispenser.

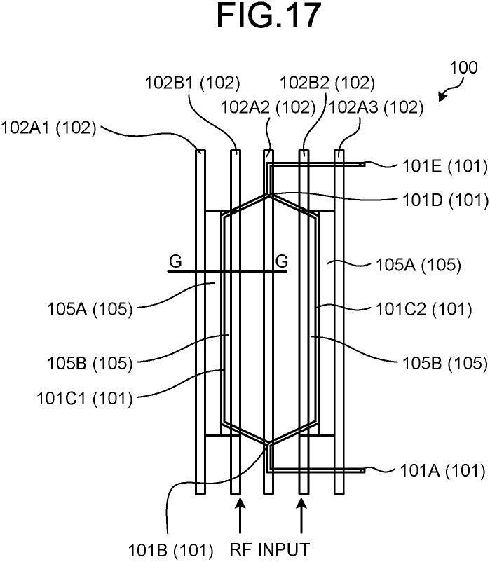

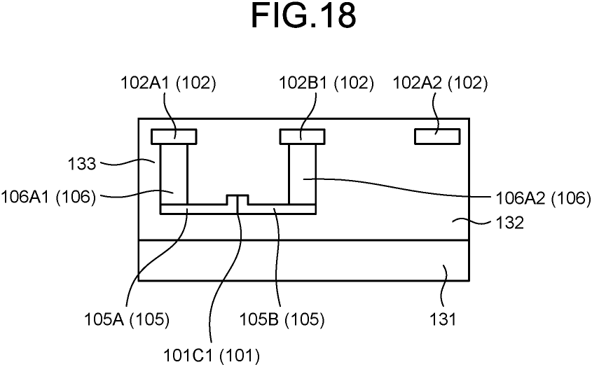

FIG. 16 is a schematic cross-sectional diagram of the second region 50B illustrated in FIG. 13 taken along line F-F. The second region 50B illustrated in FIG. 16 is a region of the optical modulator 50 in which the interaction unit 53B formed using the EO polymer 53 is disposed. The second region 50B on the first waveguide 51C1 side includes the silicon substrate 31, the intermediate layer 32 that is made of SiO₂ and that is laminated on the silicon substrate 31, and the first waveguide 51C1 that is formed on the intermediate layer 32. The second region 50B on the first waveguide 51C1 side includes the buffer layer 33 that is made of SiO₂ and that is laminated on the intermediate layer 32 including the first waveguide 51C1, and the electrode 52. Furthermore, the electrode 52 includes the first ground electrode 52A1, the first signal electrode 52B1, and the second ground electrode 52A2.

The second region 50B on the first waveguide 51C1 side includes a via layer 56A1 (56) that electrically joins a portion between the first ground electrode 52A1 and the N doped Si layer 55A1. The second region 50B on the first waveguide 51C1 side includes a via layer 56A2 (56) that electrically joins a portion between the first signal electrode 52B1 and the N doped Si layer 55A2. A second region 20B on the first waveguide 51C1 side includes the opening portion 33A1 that is formed in the buffer layer 33 located between the first ground electrode 52A1 and the first signal electrode 52B1, and the interaction unit 53B that is the EO polymer 53 injected into the opening portion 33A1. The first waveguide 51C1 is a waveguide that is in a state in which a part of the interaction unit 53B is inserted into the slot.

The second region 50B on the second waveguide 51C2 side includes the silicon substrate 31, the intermediate layer 32 that is made of SiO₂ and that is laminated on the silicon substrate 31, and the second waveguide 51C2 that is formed on the intermediate layer 32. The second region 50B on the second waveguide 51C2 side includes the buffer layer 33 that is made of SiO₂ and that is laminated on the intermediate layer 32 including the second waveguide 51C2, and the electrode 52. Furthermore, the electrode 52 includes the second ground electrode 52A2, the second signal electrode 52B2, and the third ground electrode 52A3.

The second region 50B on the second waveguide 51C2 side includes the via layer 56A1 (56) that electrically joins a portion between the third ground electrode 52A3 and the N doped Si layer 55A1. The second region 50B on the second waveguide 51C2 side includes the via layer 56A2 (56) that electrically joins a portion between the second signal electrode 52B2 and the N doped Si layer 55A2. The second region 50B on the second waveguide 51C2 side includes the opening portion 33A1 that is formed on the buffer layer 33 located between the third ground electrode 52A3 and the second signal electrode 52B2, and the interaction unit 53B that is the EO polymer 53 injected into the opening portion 33A1. A second waveguide 11C2 is a waveguide that is in a state in which a part of the interaction unit 53B is inserted into the slot.

Regarding the optical modulator 50, the EO polymer 53 is used in the slot provided in the optical waveguide 51, so that a change in the refractive index of light propagating through the optical waveguide 51 is increased. In addition, in the optical modulator 50, if a drive voltage of a high-frequency signal is applied to the first signal electrode 52B1, the phase of the light propagating through the first waveguide 51C1 is changed as a result of a change in the refractive index of the first waveguide 51C1 located between the first signal electrode 52B1 and the first ground electrode 52A1. Similarly, in the optical modulator 50, if a drive voltage of a high-frequency signal is applied to the second signal electrode 52B2, the phase of the light propagating through the second waveguide 51C2 is changed as a result of a change in the refractive index of the second waveguide 51C2 located between the second signal electrode 52B2 and the third ground electrode 52A3. Consequently, in the multiplexing portion 51D, by multiplexing the light that has been subjected to phase modulation received from the first waveguide 51C1 and the light that has been subjected to phase modulation received from the second waveguide 51C2, the optical modulator 50 is able to perform conversion, such as a change in light intensity at multilevel in accordance with a phase difference of the light.

In the optical modulator 50 according to the comparative example, the EO polymer 53 is used in the slot provided in the optical waveguide 51, so that a changed in the refractive index of the light propagating through the optical waveguide 51 is increased. Consequently, it is possible to decrease the drive voltage of the high-frequency signal applied to the first signal electrode 52B1 and the second signal electrode 52B2, and it is thus possible to suppress electric power consumption.

In the optical modulator 50 according to the comparative example, in order to fill the interior of the slot located between the N doped Si layer 55A in the optical waveguide 51 with the EO polymer 53, there is a need to etch the opening portion 33A1 in the buffer layer 33 and inject the EO polymer 53 into the opening portion 33A1.

An injection of the EO polymer 53 is performed by using a dispenser; however, the input side excessive length unit 53A and the output side excessive length unit 53C, in which the thickness of the EO polymer is increased, are consequently formed at an injection start point and an injection end point. In addition, the input side excessive length unit 53A and the output side excessive length unit 53C each having a structure whose thickness is large, so that a stress is applied to the optical waveguide. Accordingly, in the optical modulator 50 according to the comparative example, the region of each of the input side excessive length unit 53A and the output side excessive length unit 53C is constituted to have a structure in which an optical waveguide is not present.

However, for example, in the interaction unit 53B in which an electric field is applied to the EO polymer 53, a characteristic impedance is 50 Ω because an electric field is concentrated between the N doped Si layers 55A. In contrast, the N doped Si layer 55A is not present in the input side excessive length unit 53A and the output side excessive length unit 53C, and thus, an electric field is consequently applied to a wide portion located between the first ground electrode 52A1 and the first signal electrode 52B1. Therefore, the characteristic impedance is larger than 50 Ω as a result of an increase in the electric field. Consequently, the impedance is sharply changed at a contact point between the output side excessive length unit 53C (the input side excessive length unit 53A) and the interaction unit 53B and a mismatch of the impedance occurs. Then, a high-frequency signal is reflected due to the mismatch of the impedance, so that a modulation bandwidth is decreased caused by the reflected high-frequency signal.

Therefore, an embodiment of an optical modulator that is able to suppress the degree of the mismatch of the impedance between, for example, the output side excessive length unit 53C and the interaction unit 53B even if an EO polymer is used will be described as a first embodiment. Furthermore, the present invention is not limited to the embodiment.

### [A] First Embodiment

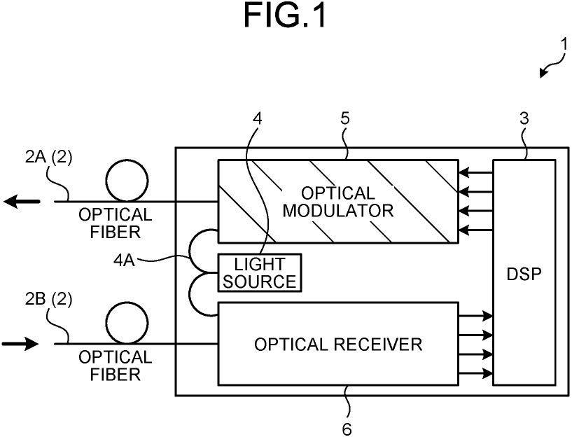

FIG. 1 is a block diagram illustrating an example of a configuration of an optical communication apparatus 1 according to the present embodiment. The optical communication apparatus 1 illustrated in FIG. 1 is connected to an optical fiber 2A (2) disposed on an output side to an optical fiber 2B (2) disposed on an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6 and obtains reception data by performing a process of, for example, decoding the acquired electrical signal or the like.

The light source 4 includes, for example, a laser diode or the like, generates light with a predetermined wavelength, and supplies the generated light to the optical modulator 5 and the optical receiver 6 through an optical waveguide 4A. The optical modulator 5 is an optical device that modulates, by using the electrical signal that is output from the DSP 3, the light supplied from the light source 4, and that outputs the obtained optical transmission signal to the optical fiber 2A. The optical modulator 5 is an optical device, such as an Si optical modulator, that includes, for example, an optical waveguide 11 and the electrode 12 having a coplanar (coplanar waveguide: CPW) structure. The optical waveguide 11 is formed on, for example, a Si crystal substrate. The optical modulator 5 generates transmission light by modulating, at the time of light supplied from the light source 4 passing through the optical waveguide 11, the light by the electrical signal that is input to the signal electrode included in the electrode 12.

The optical receiver 6 receives reception light from the optical fiber 2B, and demodulates the reception light by using the local light supplied from the light source 4. Then, the optical receiver 6 converts the demodulated reception light to an electrical signal, and outputs the converted electrical signal to the DSP 3.

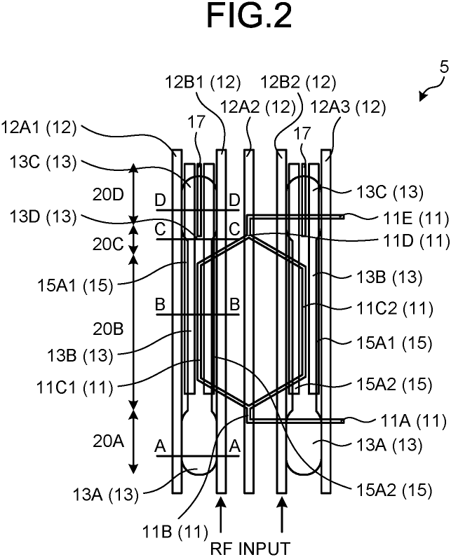

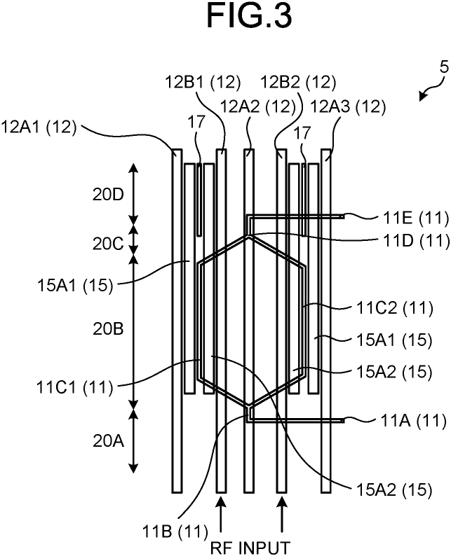

FIG. 2 is a schematic plan view illustrating an example of a configuration of the optical modulator 5 according to the first embodiment, and FIG. 3 is a schematic plan view in which a drawing of an EO polymer included in the optical modulator 5 illustrated in FIG. 2 has been omitted. The optical modulator 5 illustrated in FIG. 2 includes the optical waveguide 11, the electrode 12 that has a coplanar structure, that includes a signal electrode and a ground electrode, and that is disposed parallel to the optical waveguide 11, and an EO polymer 13 that is inserted into the slot included in the optical waveguide 11.

The optical waveguide 11 is a slot waveguide constituted of two N doped Si layers 15A. The optical waveguide 11 includes an input portion 11A, a branching portion 11B, two waveguides 11C, a multiplexing portion 11D, and an output portion 11E. The input portion 11A is an input portion of the optical modulator 5 that inputs light received from the light source 4. The branching portion 11B optically branches the light received from the input portion 11A, and outputs the branched light to the two waveguides 11C. Each of the two waveguides 11C is an arm of the optical modulator 5 that propagates the light received from the branching portion 11B and that acts on the propagating light in accordance with the electric field between the electrodes 12. The multiplexing portion 11D multiplexes the branched light received from the two waveguides 11C, and outputs the multiplexed light. The output portion 11E is an output portion of the optical modulator 5 that outputs the light received from the multiplexing portion 11D. In addition, each of the two waveguides 11C functioning as the arm is formed in, for example, the N doped Si layer; however, it is assumed that the portion of the optical waveguide 11 other than the two waveguides 11C is formed in an undoped Si layer.

The electrode 12 is constituted by using, for example, an aluminum material. The electrode 12 is an electrode having a coplanar structure including a first ground electrode 12A1, a first signal electrode 12B1, the second ground electrode 12A2, the second signal electrode 12B2, and the third ground electrode 12A3. The first signal electrode 12B1 is disposed between the first ground electrode 12A1 and the second ground electrode 12A2 so as to be parallel thereto. The second signal electrode 12B2 is disposed between the second ground electrode 12A2 and the third ground electrode 12A3 so as to be parallel thereto.

Between the two waveguides 11C, a first waveguide 11C1 is an optical waveguide that is disposed in a lower part of the region located between the first ground electrode 12A1 and the first signal electrode 12B1. The first waveguide 11C1 is a slot waveguide that is provided with a slot constituted of the two N doped Si layers 15A.

The EO polymer 13 on the first waveguide 11C1 side includes an input side excessive length unit 13A, an interaction unit 13B, an output side excessive length unit 13C, and a boundary portion 13D. The interaction unit 13B is constituted such that a part of the interaction unit 13B is inserted into the slot provided in the first waveguide 11C1, and is formed using an EO polymer that acts on the light passing through the first waveguide 11C1 in accordance with a drive voltage of a high-frequency signal applied from the first signal electrode 12B1 to the first ground electrode 12A1. The input side excessive length unit 13A is an EO polymer extending on the input side of the interaction unit 13B. The output side excessive length unit 13C is an EO polymer extending on the output side of the interaction unit 13B. The boundary portion 13D is an EO polymer located between the interaction unit 13B and the output side excessive length unit 13C.

A disposition region of each of the input side excessive length unit 13A and the boundary portion 13D is a region in which the optical waveguide 11 is not present. The interaction unit 13B forms the first waveguide 11C1 as a result of a part of the interaction unit 13B being injected into the slot located between an N doped Si layer 15A1 that is the first doped layer and an N doped Si layer 15A2 that is the second doped layer. Furthermore, the output side excessive length unit 13C forms a dummy waveguide 17 that is another waveguide that is not connected to the first waveguide 11C1 and that is formed using the EO polymer 13 that is formed in the slot located between the N doped Si layer 15A1 and the N doped Si layer 15A2. The dummy waveguide 17 is a waveguide that is not used to pass the light but is used to concentrate an electric field on a position between the N doped Si layer 15A1 that is connected to the first ground electrode 12A1 and the N doped Si layer 15A2 that is connected to the first signal electrode 12B1. Consequently, the electric field that acts on the dummy waveguide 17 approaches the electric field that acts on the first waveguide 11C1, so that it is possible to suppress a change in the characteristic impedance.

Between the two waveguides 11C, the second waveguide 11C2 is an optical waveguide that is disposed at a lower part of the region located between the second signal electrode 12B2 and the third ground electrode 12A3. The second waveguide 11C2 is a slot waveguide that is provided with a slot constituted of the two N doped Si layers 15A.

The EO polymer 13 on the second waveguide 11C2 side also includes the input side excessive length unit 13A, the interaction unit 13B, the output side excessive length unit 13C, and the boundary portion 13D. The interaction unit 13B is constituted such that a part of the interaction unit 13B is inserted into the slot provided in the second waveguide 11C2, and is made of an EO polymer that acts on the light passing through the second waveguide 11C2 in accordance with a drive voltage of a high-frequency signal applied from the second signal electrode 12B2 to the third ground electrode 12A3. The input side excessive length unit 13A is an EO polymer extending on the input side of the interaction unit 13B. The output side excessive length unit 13C is an EO polymer extending on the output side of the interaction unit 13B. The boundary portion 13D is an EO polymer located between the interaction unit 13B and the output side excessive length unit 13C.

A disposition region of each of the input side excessive length unit 13A and the boundary portion 13D is a region in which the optical waveguide 11 is not present. The interaction unit 13B forms the second waveguide 11C2 as a result of a part of the interaction unit 13B being injected into the slot that is located between the N doped Si layer 15A1 and the N doped Si layer 15A2. Furthermore, the output side excessive length unit 13C forms the dummy waveguide 17 that is not connected to the second waveguide 11C2 and that is formed using the EO polymer 13 that is formed in the slot located between the N doped Si layer 15A1 and the N doped Si layer 15A2. The dummy waveguide 17 is a waveguide that is not used to pass light but is used to concentrate the electric field on a portion between the N doped Si layer 15A1 that is connected to the third ground electrode 12A3 and the N doped Si layer 15A2 that is connected to the second signal electrode 12B2. Consequently, the electric field that acts on the dummy waveguide 17 approaches the electric field that acts on the second waveguide 11C2, so that it is possible to suppress a change in the characteristic impedance.

The optical modulator 5 includes the first region 20A, the second region 20B, a third region 20C, and a fourth region 20D. It is assumed that the optical modulator 5 is disposed in the order of the first region 20A, the second region 20B, the third region 20C, and the fourth region 20D in a travelling direction of light passing from an input toward an output of light.

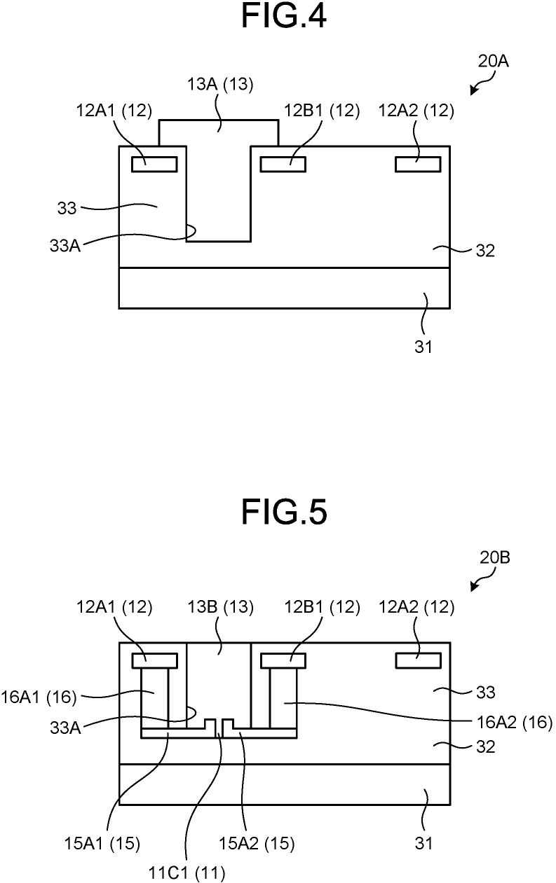

FIG. 4 is a schematic cross-sectional diagram of the first region 20A illustrated in FIG. 2 taken along line A-A. The first region 20A illustrated in FIG. 4 is a region of the optical modulator 5 in which the input side excessive length unit 13A formed using the EO polymer 13 is disposed. The first region 20A on the first waveguide 11C1 side includes the silicon substrate 31, the intermediate layer 32 that is made of SiO₂ and that is laminated on the silicon substrate 31, the buffer layer 33 that is made of SiO₂ and that is laminated on the intermediate layer 32, and the electrode 12. In addition, the electrode 12 includes the first ground electrode 12A1, the first signal electrode 12B1, and the second ground electrode 12A2.

The first region 20A on the first waveguide 11C1 side includes an opening portion 33A that is formed in the buffer layer 33 located between the first ground electrode 12A1 and the first signal electrode 12B1, and the input side excessive length unit 13A that is formed using the EO polymer 13 injected into the opening portion 33A. In addition, the EO polymer 13 forms the input side excessive length unit 13A as a result of being injected into the opening portion 33A by using, for example, a dispenser.

The first region 20A on the second waveguide 11C2 side includes the silicon substrate 31, the intermediate layer 32 that is made of SiO₂ and that is laminated on the silicon substrate 31, the buffer layer 33 that is made of SiO₂ and that is laminated on the intermediate layer 32, and the electrode 12. In addition, the electrode 12 includes the second ground electrode 12A2, the second signal electrode 12B2, and the third ground electrode 12A3. The first region 20A on the second waveguide 11C2 side includes the opening portion 33A that is formed in the buffer layer 33 located between the third ground electrode 12A3 and the second signal electrode 12B2, and the input side excessive length unit 13A that is formed using the EO polymer 13 injected into the opening portion 33A. In addition, the EO polymer 13 consequently forms the input side excessive length unit 13A as a result of being injected into the opening portion 33A by using, for example, a dispenser.

FIG. 5 is a schematic cross-sectional diagram of the second region 20B illustrated in FIG. 2 taken along line B-B. The second region 20B illustrated in FIG. 5 is a region of the optical modulator 5 in which the interaction unit 13B formed using the EO polymer 13 is disposed. The second region 20B on the first waveguide 11C1 side includes the silicon substrate 31, the intermediate layer 32 that is made of SiO₂ and that is laminated on the silicon substrate 31, and the first waveguide 11C1 that is formed on the intermediate layer 32. Furthermore, the second region 20B on the first waveguide 11C1 side includes the buffer layer 33 that is made of SiO₂ and that is laminated on the intermediate layer 32 including the first waveguide 11C1, and the electrode 12. In addition, the electrode 12 includes the first ground electrode 12A1, the first signal electrode 12B1, and the second ground electrode 12A2.

The second region 20B on the first waveguide 11C1 side includes a via layer 16A1 (16) that electrically joins a portion between the first ground electrode 12A1 and the N doped Si layer 15A1. The via layer 16 is constituted of, for example, aluminum, that is the same material as that of the electrode 12. The second region 20B on the first waveguide 11C1 side includes a via layer 16A2 (16) that electrically joins a portion between the first signal electrode 12B1 and the N doped Si layer 15A2. The second region 20B on the first waveguide 11C1 side includes the opening portion 33A that is formed in the buffer layer 33 located between the first ground electrode 12A1 and the first signal electrode 12B1, and the interaction unit 13B that is formed using the EO polymer 13 injected into the opening portion 33A. The first waveguide 11C1 is a slot waveguide in a state in which a part of the interaction unit 13B is inserted into the slot located between the N doped Si layer 15A1 that is connected to the first ground electrode 12A1 and the N doped Si layer 15A2 that is connected to the first signal electrode 12B1.

The second region 20B on the second waveguide 11C2 side includes the silicon substrate 31, the intermediate layer 32 that is made of SiO₂ and that is laminated on the silicon substrate 31, and the second waveguide 11C2 that is formed on the intermediate layer 32. The second region 20B on the second waveguide 11C2 side includes the buffer layer 33 that is made of SiO₂ and that is laminated on the intermediate layer 32 including the second waveguide 11C2, and the electrode 12. In addition, the electrode 12 includes the second ground electrode 12A2, the second signal electrode 12B2, and the third ground electrode 12A3.

The second region 20B on the second waveguide 11C2 side includes the via layer 16A1 (16) that electrically joins a portion between the third ground electrode 12A3 and the N doped Si layer 15A1. The second region 20B on the second waveguide 11C2 side includes the via layer 16A2 (16) that electrically joins a portion between the second signal electrode 12B2 and the N doped Si layer 15A2. The second region 20B on the second waveguide 11C2 side includes the opening portion 33A that is formed in the buffer layer 33 located between the third ground electrode 12A3 and the second signal electrode 12B2, and the interaction unit 13B that is formed using the EO polymer 13 injected into the opening portion 33A. The second waveguide 11C2 is a slot waveguide in a state in which a part of the interaction unit 13B is inserted into the slot located between the N doped Si layer 15A1 that is connected to the third ground electrode 12A3 and the N doped Si layer 15A2 that is connected to the second signal electrode 12B2.

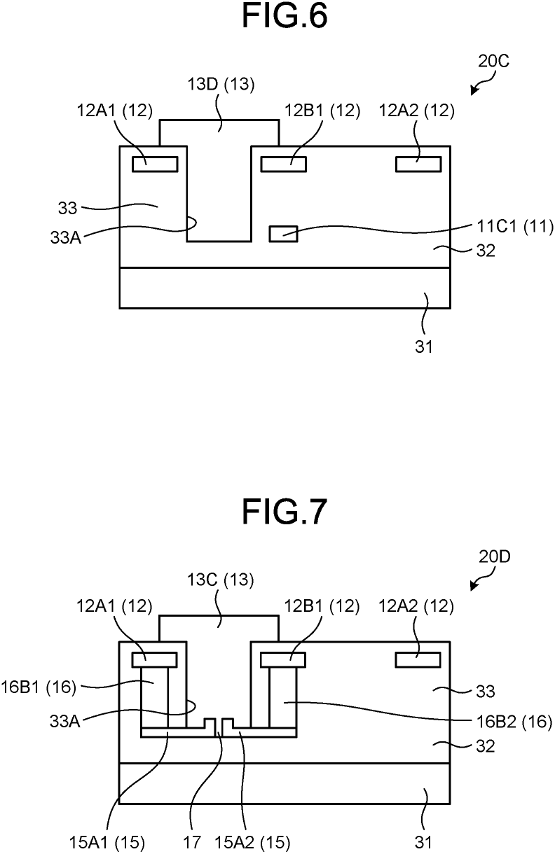

FIG. 6 is a schematic cross-sectional diagram of the third region 20C illustrated in FIG. 2 taken along line C-C. The third region 20C illustrated in FIG. 6 is a region of the optical modulator 5 in which the boundary portion 13D that is formed using the EO polymer 13 is disposed. The third region 20C on the first waveguide 11C1 side includes the silicon substrate 31, the intermediate layer 32 that is made of SiO₂ and that is laminated on the silicon substrate 31, the buffer layer 33 that is made of SiO₂ and that is laminated on the intermediate layer 32, and the electrode 12. In addition, the electrode 12 includes the first ground electrode 12A1, the first signal electrode 12B1, and the second ground electrode 12A2. The third region 20C on the first waveguide 11C1 side includes the opening portion 33A that is formed in the buffer layer 33 located between the first ground electrode 12A1 and the first signal electrode 12B1, the boundary portion 13D that is formed using the EO polymer 13 inserted into the opening portion 33A, and the first waveguide 11C1.

The third region 20C on the second waveguide 11C2 side includes the silicon substrate 31, the intermediate layer 32 that is made of SiO₂ and that is laminated on the silicon substrate 31, the buffer layer 33 that is made of SiO₂ and that is laminated on the intermediate layer 32, and the electrode 12. In addition, the electrode 12 includes the second ground electrode 12A2, the second signal electrode 12B2, and the third ground electrode 12A3. The third region 20C on the second waveguide 11C2 side includes the opening portion 33A that is formed in the buffer layer 33 located between the third ground electrode 12A3 and the second signal electrode 12B2, the boundary portion 13D that is formed using the EO polymer 13 inserted into the opening portion 33A, and the second waveguide 11C2.

FIG. 7 is a schematic cross-sectional diagram of the fourth region 20D illustrated in FIG. 2 taken along line D-D. The fourth region 20D illustrated in FIG. 7 is a region of the optical modulator 5 disposed in the output side excessive length unit 13C formed using the EO polymer 13. The fourth region 20D on the first waveguide 11C1 side includes the silicon substrate 31, the intermediate layer 32 that is made of SiO₂ and that is laminated on the silicon substrate 31, and the dummy waveguide 17 that is formed on the intermediate layer 32. The fourth region 20D on the first waveguide 11C1 side includes the buffer layer 33 that is made of SiO₂ and that is laminated on the intermediate layer 32 including the dummy waveguide 17, and the electrode 12. In addition, the electrode 12 includes the first ground electrode 12A1, the first signal electrode 12B1, and the second ground electrode 12A2.

The fourth region 20D on the first waveguide 11C1 side includes a via layer 16B1 (16) that electrically joins a portion between the first ground electrode 12A1 and the N doped Si layer 15A1. The fourth region 20D on the first waveguide 11C1 side includes a via layer 16B2 (16) that electrically joins a portion between the first signal electrode 12B1 and the N doped Si layer 15A2. The fourth region 20D on the first waveguide 11C1 side includes the opening portion 33A that is formed in the buffer layer 33 located between the first ground electrode 12A1 and the first signal electrode 12B1, the output side excessive length unit 13C that is formed using the EO polymer 13 inserted into the opening portion 33A, and the dummy waveguide 17. The dummy waveguide 17 is a slot waveguide that is in a state in which a part of the output side excessive length unit 13C is inserted into the slot located between the N doped Si layer 15A1 that is connected to the first ground electrode 12A1 and the N doped Si layer 15A2 that is connected to the first signal electrode 12B1. The dummy waveguide 17 is a waveguide that is in a state in which the dummy waveguide 17 is not electrically connected to the first waveguide 11C1.

The fourth region 20D on the second waveguide 11C2 side includes the silicon substrate 31, the intermediate layer 32 that is made of SiO₂ and that is laminated on the silicon substrate 31, and the dummy waveguide 17 that is formed on the intermediate layer 32. The fourth region 20D on the second waveguide 11C2 side includes the buffer layer 33 that is made of SiO₂ and that is laminated on the intermediate layer 32 including the dummy waveguide 17, and the electrode 12. In addition, the electrode 12 includes the second ground electrode 12A2, the second signal electrode 12B2, and the third ground electrode 12A3.

The fourth region 20D on the second waveguide 11C2 side includes the via layer 16B1 (16) that electrically joins a portion between the third ground electrode 12A3 and the N doped Si layer 15A1. The fourth region 20D on the second waveguide 11C2 side includes the via layer 16B2 (16) that electrically joins a portion between the second signal electrode 12B2 and the N doped Si layer 15A2. The fourth region 20D on the second waveguide 11C2 side includes the opening portion 33A that is formed in the buffer layer 33 located between the third ground electrode 12A3 and the second signal electrode 12B2, the output side excessive length unit 13C that is formed using the EO polymer 13 inserted into the opening portion 33A, and the dummy waveguide 17. The dummy waveguide 17 is a slot waveguide that is in a state in which a part of the output side excessive length unit 13C is inserted into the slot located between the N doped Si layer 15A1 that is connected to the third ground electrode 12A3 and the N doped Si layer 15A2 that is connected to the second signal electrode 12B2. The dummy waveguide 17 is a waveguide that is in a state in which the dummy waveguide 17 is not electrically connected to the second waveguide 11C2.

The fourth region 20D on the first embodiment includes the dummy waveguide 17 that is formed by a part of the output side excessive length unit 13C that is inserted into the slot located between the N doped Si layer 15A1 that is connected to the first ground electrode 12A1 and the N doped Si layer 15A2 that is connected to the first signal electrode 12B1. The fourth region 20D in which the output side excessive length unit 13C has been disposed is constituted such that, similarly to the optical waveguide 11 included in the interaction unit 13B, the dummy waveguide 17 in which an electric field is concentrated in accordance with a drive voltage of a high-frequency signal applied from the first signal electrode 12B1 to the first ground electrode 12A1 is disposed. Consequently, the degree of a mismatch between the characteristic impedance of the interaction unit 13B and the characteristic impedance of the output side excessive length unit 13C is suppressed, so that a modulation bandwidth is increased as a result of reflection of the high-frequency signal being suppressed.

An N doped Si layer 15 has electricity resistance that is larger than that of the electrode 12 made of aluminum, so that, if an electric field is applied to the N doped Si layer 15, a propagation loss of the high-frequency signal applied to the electrode 12 is increased. Accordingly, it is assumed that the N doped Si layer 15 is disposed only in the fourth region 20D in which the output side excessive length unit 13C has been disposed, and the N doped Si layer 15 is not disposed in the first region 20A in which the input side excessive length unit 13A is disposed.

In addition, a case has been described as an example in which the first region 20A, in which the input side excessive length unit 13A included in the optical modulator 5 according to the first embodiment is disposed, is constituted by an aluminum electrode formed by the first ground electrode 12A1 and the first signal electrode 12B1. However, if the first region 20A is constituted such that the first ground electrode 12A1 and the first signal electrode 12B1 are formed by aluminum electrodes, the characteristic impedance is increased. Consequently, an impedance mismatch occurs between the first region 20A and the second region 20B, and reflection of the high-frequency signal occurs. Accordingly, an embodiment of solving this circumstance will be described below as a second embodiment. In addition, by assigning the same reference numerals to components having the same configuration as those in the optical modulator 5 according to the first embodiment, overlapped descriptions of the configuration and the operation thereof will be omitted.

### [B] Second Embodiment

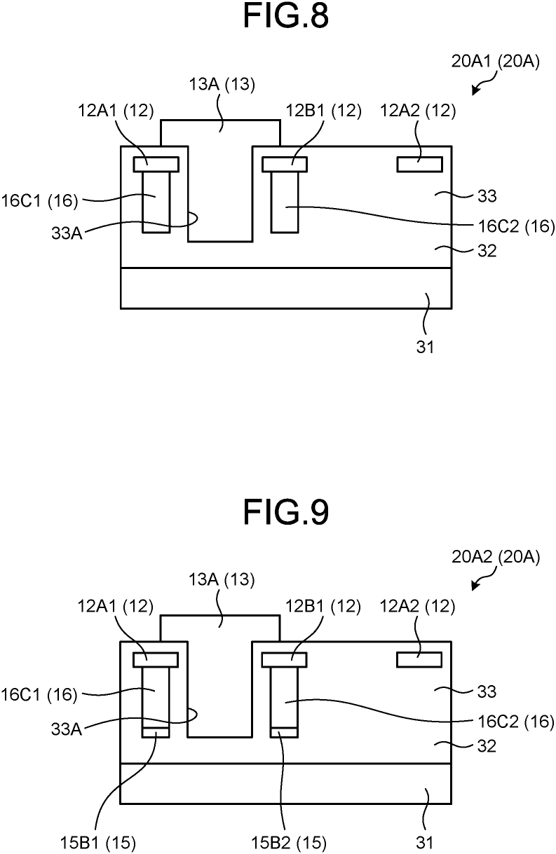

FIG. 8 is a schematic cross-sectional diagram of a first region 20A1 included in the optical modulator 5 according to a second embodiment taken along line A-A. The first region 20A1 on the first waveguide 11C1 side illustrated in FIG. 8 includes a via layer 16C1 that is electrically joined to the first ground electrode 12A1, and a via layer 16C2 that is electrically joined to the first signal electrode 12B1. The via layer 16C1 is an aluminum via layer that has the same cross-sectional structure as that of the via layer 16A1 that is electrically joined to the first ground electrode 12A1 in the second region 20B in which the interaction unit 13B is disposed. The via layer 16C2 is an aluminum via layer having the same cross-sectional structure as that of the via layer 16A2 that is electrically joined to the first signal electrode 12B1 in the second region 20B in which the interaction unit 13B is disposed. The via layers 16C1 and 16C2 are second via layers, whereas the via layers 16A1 and 16A2 are first via layers.

Furthermore, the first region 20A1 on the second waveguide 11C2 side also has the via layer 16C1 that is connected to the third ground electrode 12A3, and the via layer 16C2 that is connected to the second signal electrode 12B2. The via layer 16C1 is an aluminum via layer having the same cross-sectional structure as that of the via layer 16A1 that is electrically joined to the third ground electrode 12A3 of the interaction unit 13B. The via layer 16C2 is an aluminum via layer having the same cross-sectional structure as that of the via layer 16A2 that is electrically joined to the second signal electrode 12B2 of the interaction unit 13B.

The electrode 12 disposed parallel to the input side excessive length unit 13A included in the optical modulator 5 according to the second embodiment is connected to the via layers 16C1 and 16C2 that are made of aluminum and that have the same cross-sectional structure as that of the via layers 16A1 and 16A2 that are connected to the electrode 12 disposed parallel to the interaction unit 13B. Consequently, the first region 20A in which the input side excessive length unit 13A is disposed and the second region 20B in which the interaction unit 13B is disposed are constituted by the electrodes and the via layers that are formed to have the same cross-sectional structure using the same material, so that the characteristic impedance of the first region 20A is decreased in the input side excessive length unit 13A. Therefore, by suppressing the degree of an impedance mismatch between the first region 20A and the second region 20B, it is possible to increase a modulation bandwidth by suppressing reflection of the high-frequency signal.

In addition, for convenience of description, a case has been described as an example in which the via layers 16C1 and 16C2 in the first region 20A1 according to the second embodiment and the via layers 16A1 and 16A2 in the second region 20B have the same cross-sectional structure; however, the example is not limited to this, and appropriate modifications are possible as long as the cross-sectional areas are similar.

Furthermore, a case has been described as an example in which, in the first region 20A1 of the optical modulator 5 according to the second embodiment, the via layer 16 that is electrically joined to the electrode 12 is disposed; however, there may be a case in which it is difficult to manufacture the via layer 16 that is not connected to the N doped Si layer. Accordingly, an embodiment of the first region 20A1 that includes the via layer 16 that is connected to the N doped Si layer will be described as a third embodiment. In addition, by assigning the same reference numerals to components having the same configuration as those in the optical modulator 5 according to the second embodiment, overlapped descriptions of the configuration and the operation thereof will be omitted.

### [C] Third Embodiment

FIG. 9 is a schematic cross-sectional diagram of a first region 20A2 included in the optical modulator 5 according to the third embodiment taken along line A-A. The first region 20A2 on the first waveguide 11C1 side illustrated in FIG. 9 includes an N doped Si layer 15B1, and the via layer 16C1 that electrically joins a portion between the first ground electrode 12A1 and the N doped Si layer 15B1. The first region 20A2 on the first waveguide 11C1 side includes an N doped Si layer 15B2, and the via layer 16C2 that electrically joins a portion between the first signal electrode 12B1 and the N doped Si layer 15B2.

The via layer 16C1 is a via layer that has the same cross-sectional structure as that of the via layer 16A1 that is electrically joined to the first ground electrode 12A1 of the interaction unit 13B. The N doped Si layer 15B1 is an N doped Si layer that has the same cross-sectional structure as that of the N doped Si layer 15A1 that is connected to the via layer 16A1 that is connected to the first ground electrode 12A1 of the interaction unit 13B. The via layer 16C2 is a via layer that has the same cross-sectional structure as that of the via layer 16A2 that is electrically joined to the first signal electrode 12B1 of the interaction unit 13B. The N doped Si layer 15B2 is an N doped Si layer that has the same cross-sectional structure as that of the N doped Si layer 15A2 that is connected to the via layer 16A2 that is connected to the first signal electrode 12B1 of the interaction unit 13B. In addition, the N doped Si layer 15B1 that is the third doped layer is sufficiently away from the N doped Si layer 15B2 that is the fourth doped layer, so that it is possible to suppress degradation of a propagation loss of a high-frequency signal. The via layers 16C1 and 16C2 are the second via layers.

Furthermore, the first region 20A1 on the second waveguide 11C2 side also includes the N doped Si layer 15B1, and the via layer 16C1 that electrically joins a portion between the third ground electrode 12A3 and the N doped Si layer 15B1. The first region 20A1 on the second waveguide 11C2 side also includes the N doped Si layer 15B2, and the via layer 16C2 that electrically joins a portion between the second signal electrode 12B2 and the N doped Si layer 15B2. The via layer 16C1 is a via layer that has the same cross-sectional structure as that of the via layer 16A1 that is electrically joined to the third ground electrode 12A3 of the interaction unit 13B. The N doped Si layer 15B1 is an N doped Si layer that has the same cross-sectional structure as that of the N doped Si layer 15A1 that is connected to the via layer 16A1 that is connected to the third ground electrode 12A3 of the interaction unit 13B. The via layer 16C2 is a via layer that has the same cross-sectional structure as that of the via layer 16A2 that is electrically joined to the second signal electrode 12B2 of the interaction unit 13B. The N doped Si layer 15B2 is an N doped Si layer that has the same cross-sectional structure as that of the N doped Si layer 15A2 that is connected to the via layer 16A2 that is connected to the second signal electrode 12B2 of the interaction unit 13B. In addition, the N doped Si layer 15B1 is sufficiently away from the N doped Si layer 15B2, so that is it possible to suppress degradation of a propagation loss of a high-frequency signal.

The electrode 12 that is disposed parallel to the input side excessive length unit 13A according to the third embodiment is connected to the via layers 16C1 and 16C2 and the N doped Si layers 15B1 and 15B2 that have the same cross-sectional structure as those of the via layers 16A1 and 16A2 and the N doped Si layers 15A1 and 15A2, respectively, that are connected to the electrode 12 that is disposed parallel to the interaction unit 13B. Consequently, similarly to the second region 20B, the first region 20A includes a via layer that is connected to the N doped Si layer, so that it is possible to easily manufacture the first region 20A.

In addition, in the third region 20C included in the optical modulator 5 according to the first embodiment, as the waveguide 11C is gradually away from the EO polymer 13 in a direction toward the multiplexing portion 11D, the N doped Si layer 15 is consequently terminated at that portion. Then, an impedance is increased at the portion in which the N doped Si layer 15 is terminated; however, a mismatch of that characteristic impedance occurs, thus affecting degradation of a modulation bandwidth. Accordingly, in order to cope with the circumstances, an embodiment thereof will be described below as a fourth embodiment. In addition, by assigning the same reference numerals to components having the same configuration as those in the optical modulator 5 according to the first embodiment, overlapped descriptions of the configuration and the operation thereof will be omitted.

### [D] Fourth Embodiment

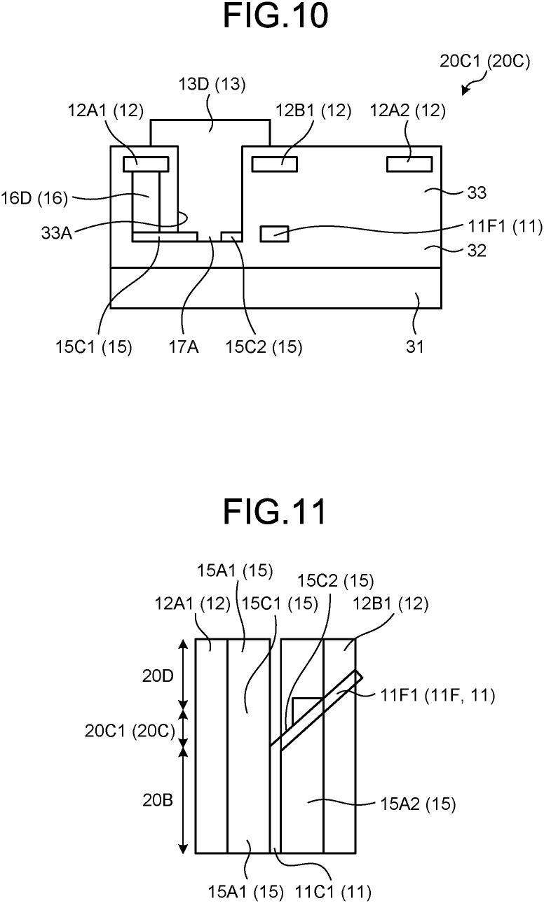

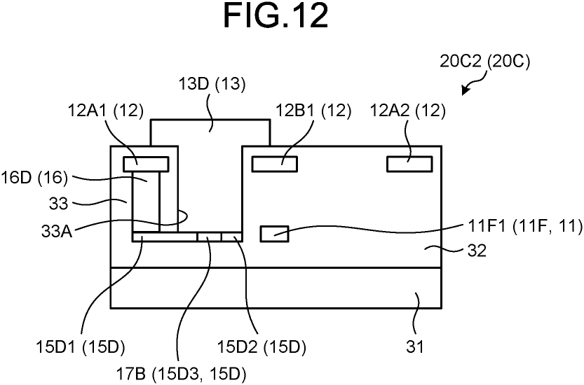

FIG. 10 is a schematic cross-sectional diagram of a third region 20C1 included in the optical modulator 5 according to the fourth embodiment taken along line C-C, and FIG. 11 is a schematic plan view in which a drawing of the EO polymer 13 included in the third region 20C1 in the optical modulator 5 according to the fourth embodiment has been omitted. The third region 20C1 on the first waveguide 11C1 side illustrated in FIG. 10 includes an N doped Si layer 15C1 that is the fifth doped layer, and an N doped Si layer 15C2 that is the sixth doped layer. The third region 20C1 on the first waveguide 11C1 side includes a via layer 16D (16) that is the third via layer and that electrically joins a portion between the first ground electrode 12A1 and the N doped Si layer 15C1. The third region 20C1 on the first waveguide 11C1 side includes a portion 11F1 (11F) disposed between the first waveguide 11C1 and the multiplexing portion 11D, and a first dummy waveguide 17A. In addition, the portion 11F1 is formed by an undoped Si layer, so that it is possible to suppress the effect of an electric field applied to the first dummy waveguide 17A.

The first dummy waveguide 17A is a slot waveguide that is in a state in which a part of the boundary portion 13D is inserted into the slot that is located between the N doped Si layer 15C1 and the N doped Si layer 15C2. In addition, a portion between the first ground electrode 12A1 and the N doped Si layer 15C1 is connected by the via layer 16D, however, a portion between the first signal electrode 12B1 and the N doped Si layer 15C2 is not connected by a via layer. The thickness of the first dummy waveguide 17A is made thinner than that of the first waveguide 11C1.

The third region 20C1 on the second waveguide 11C2 side includes the N doped Si layer 15C1, the N doped Si layer 15C2, and the via layer 16D (16) that electrically joins a portion between the third ground electrode 12A3 and the N doped Si layer 15C1. The third region 20C1 on the second waveguide 11C2 side includes a portion 11F2 disposed between the second waveguide 11C2 and the multiplexing portion 11D, and the first dummy waveguide 17A. In addition, the portion 11F2 is formed by an undoped Si layer, so that it is possible to suppress the effect of an electric field applied to the first dummy waveguide 17A.

The first dummy waveguide 17A is a slot waveguide that is in a state in which a part of the boundary portion 13D is inserted into the slot that is located between the N doped Si layer 15C1 and the N doped Si layer 15C2. In addition, a portion between the third ground electrode 12A3 and the N doped Si layer 15C1 is connected by the via layer 16D, however, a portion between the second signal electrode 12B2 and the N doped Si layer 15C2 is not connected by a via layer. The thickness of the first dummy waveguide 17A is made thinner than that of the second waveguide 11C2.

The third region 20C1 included in the optical modulator 5 according to the fourth embodiment includes the portion 11F that has been formed by an undoped Si layer located between the waveguide 11C and the multiplexing portion 11D, and the first dummy waveguide 17A. Furthermore, the first dummy waveguide 17A is constituted to have a structure such that the thickness of the first dummy waveguide 17A is thinner than that of the portion 11F of the optical waveguide 11. The portion 11F is able to avoid a mismatch of an impedance by concentrating the electric field between the N doped Si layers 15C1 and 15C2 by preventing propagation of light from the N doped Si layer 15C2 to the portion 11F while gradually separating from the EO polymer 13 in a direction from the waveguide 11C toward the multiplexing portion 11D.

The third region 20C1 includes the first dummy waveguide 17A in which a part of the boundary portion 13D is inserted into the slot that is located between the N doped Si layer 15C1, which is connected to the first ground electrode 12A1 via the via layer 16D, and the N doped Si layer 15C2. Consequently, it is possible to suppress the degree of an impedance mismatch between the characteristic impedance of the third region 20C1 and the characteristic impedance of the second region 20B.

In addition, a case has been described as an example in which the first dummy waveguide 17A is formed in the third region 20C1 included in the optical modulator 5 according to the fourth embodiment in a state in which a part of the boundary portion 13D is inserted into the slot that is located between the N doped Si layer 15C1 and the N doped Si layer 15C2. However, there may be a case in which it is difficult to provide a slot between the thin N doped Si layers 15C1 and 15C2. Accordingly, in order to cope with the circumstances, an embodiment thereof will be described below as a fifth embodiment. In addition, by assigning the same reference numerals to components having the same configuration as those in the optical modulator 5 according to the first embodiment, overlapped descriptions of the configuration and the operation thereof will be omitted.

### [E] Fifth Embodiment

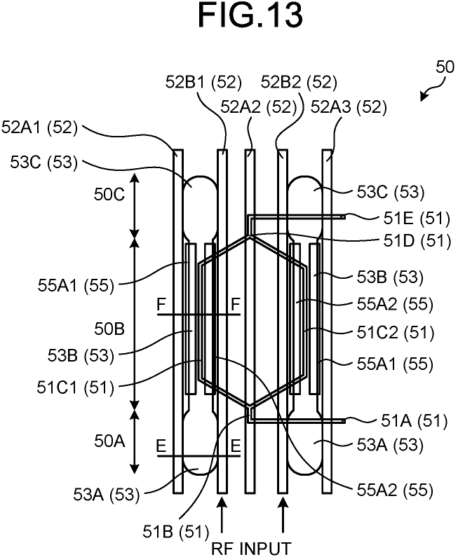

FIG. 12 is a schematic cross-sectional diagram of a third region 20C2 included in the optical modulator 5 according to the fifth embodiment taken along line C-C. A first dummy waveguide 17B included in the third region 20C2 on the first waveguide 11C1 side illustrated in FIG. 12 is formed in a Si layer 15D that is electrically connected to a lower part of the via layer 16D and the boundary portion 13D. Then, it is assumed that the Si layer 15D that is connected to the via layer 16D is an N doped Si layer 15D1 that is the fifth doped layer and it is assumed that the Si layer 15D that is connected to a part of the boundary portion 13D is an N doped Si layer 15D2 that is the sixth doped layer. Furthermore, it is assumed that the Si layer 15D located between the N doped Si layer 15D1 and the N doped Si layer 15D1 is an undoped Si layer 15D3. Consequently, the first dummy waveguide 17B functions as a dielectric substance, and is thus able to adjust the characteristic impedance by adjusting the undoped Si layer 15D3.

The first dummy waveguide 17B included in the third region 20C2 included in the second waveguide 11C2 side is formed in the Si layer 15D that is electrically connected to a lower part of the via layer 16D and the boundary portion 13D. Then, it is assumed that the Si layer 15D connected to the via layer 16D is the N doped Si layer 15D1, the Si layer 15D connected to a part of the boundary portion 13D is the N doped Si layer 15D2, and the Si layer 15D located between the N doped Si layer 15D1 and the N doped Si layer 15D1 is the undoped Si layer 15D3. Consequently, the first dummy waveguide 17B functions as a dielectric substance, and is thus able to adjust the characteristic impedance by adjusting the undoped Si layer 15D3.

The first dummy waveguide 17B included in the optical modulator 5 according to the fifth embodiment is formed by disposing the undoped Si layer 15D3 between the N doped Si layer 15D1 and the N doped Si layer 15D2. Consequently, there is no need to form a slot as described above in the fourth embodiment, so that it is possible to easily manufacture the first dummy waveguide 17B even if the Si layer 15D is thin.

In addition, for convenience of description, a case has been described as an example in which the dummy waveguide 17 is formed only in the fourth region 20D included in the optical modulator 5 in consideration of a propagation loss of a high-frequency signal applied to the electrode 12. However, it may be possible to form the dummy waveguide 17 in a part of the input side excessive length unit 13A injected into the slot located between the N doped Si layer 15A included in the first region 20A in the optical modulator 5 as long as another measure is taken to compensate a propagation loss of the high-frequency signal applied to the electrode 12.

A case has been described as an example in which the optical waveguide 11 and the dummy waveguide 17 are constituted by the N doped Si layer 15; however, instead of the N doped Si layer 15, the P doped Si layer may be used, and appropriate modifications are possible. In addition, the Si layer has been used as an example; however, for example, a SiGe layer may be used, and appropriate modifications are possible.

In addition, in the optical modulator 5 according to the first embodiment to the fifth embodiment, the optical modulator having the GSG structure including the first ground electrode 12A1, the first signal electrode 12B1, the second ground electrode 12A2, the second signal electrode 12B2, and the third ground electrode 12A3 has been described as an example. However, the embodiment is not limited to this structure, an optical modulator having a GSSG structure may be used, and appropriate modifications are possible.

In the optical modulator 5 according to the first embodiment described above, a case of the GSG structure having three ground electrodes and two signal electrodes has been described as an example; however, the number of ground electrodes and signal electrodes are not limited to these, and appropriate modifications are possible.

A case has been described as an example in which the electrode 12 is constituted by using, for example, aluminum; however, the example is not limited to this and, the electrode 12 may be constituted by using a material made of, for example, gold, silver, or copper, and appropriate modifications are possible.

According to an aspect of an embodiment of the optical device or the like disclosed in the present application, modulation efficiency is improved while suppressing electric power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a waveguide;
an electrode that has a coplanar structure and that includes a signal electrode and a ground electrode that are disposed parallel to the waveguide;
an interaction unit that is constituted such that a part of the interaction unit is inserted into a slot provided in the waveguide, that is formed using an electro-optical polymer, and that acts on light passing through the waveguide in accordance with a drive voltage of a highfrequency signal received from the electrode;
an excessive length unit that extends to an input side and an output side of the interaction unit and that is formed using the electro-optical polymer; and
an other waveguide that is not connected to the waveguide and that is formed by inserting a part of the excessive length unit into the slot located between a first doped layer that is connected to the ground electrode that is disposed parallel to the excessive length unit and a second doped layer that is connected to the signal electrode that is disposed parallel to the excessive length unit.

2. The optical device according to claim 1, wherein the waveguide is formed by inserting the part of the interaction unit into the slot located between the first doped layer that is connected to the ground electrode that is disposed parallel to the interaction unit and the second doped layer that is connected to the signal electrode that is disposed parallel to the interaction unit.

3. The optical device according to claim 1, wherein the other waveguide is formed by inserting the part of the excessive length unit on the output side into the slot located between the first doped layer that is connected to the ground electrode that is disposed parallel to the excessive length unit on the output side and the second doped layer that is connected to the signal electrode that is disposed parallel to the excessive length unit on the output side.

4. The optical device according to claim 3, wherein the electrode that is disposed parallel to the excessive length unit on the input side is connected to a second via layer that has a cross-sectional structure having substantially the same cross-sectional area as a cross-sectional area of a first via layer that is connected to the electrode that is disposed parallel to the interaction unit.

5. The optical device according to claim 4, further including:
a third doped layer that is connected to the second via layer that is connected to the ground electrode included in the electrode that is disposed parallel to the excessive length unit on the input side; and
a fourth doped layer that is connected to the second via layer that is connected to the signal electrode included in the electrode that is disposed parallel to the excessive length unit on the input side.

6. The optical device according to claim 1, wherein,
in a region in which a boundary portion is formed using the electro-optical polymer located between the interaction unit and the excessive length unit on the output side, the waveguide and the other waveguide are included, and
a thickness of the other waveguide is made thinner than a thickness of the waveguide.

7. The optical device according to claim 1, further including, in a region in which a boundary portion is formed using the electro-optical polymer located between the interaction unit and the excessive length unit on the output side:
a fifth doped layer that is connected to a third via layer that is connected to the ground electrode;
a sixth doped layer that is connected to the boundary portion; and
a waveguide that is connected to the other waveguide and that is formed by inserting a part of the boundary portion into a slot located between the fifth doped layer and the sixth doped layer.

8. The optical device according to claim 1, further including, in a region in which a boundary portion is formed using the electro-optical polymer located between the interaction unit and the excessive length unit on the output side:
a fifth doped layer that is connected to a third via layer that is connected to the ground electrode;
a sixth doped layer that is connected to the boundary portion; and
a waveguide that is connected to the other waveguide and that is formed of an undoped silicon layer provided between the fifth doped layer and the sixth doped layer.

9. An optical modulator comprising:
a waveguide;
an electrode that has a coplanar structure and that includes a signal electrode and a ground electrode that are disposed parallel to the waveguide;
an interaction unit that is constituted such that a part of the interaction unit is inserted into a slot provided in the waveguide, that is formed using an electro-optical polymer, and that acts on light passing through the waveguide in accordance with a drive voltage of a highfrequency signal received from the electrode;
an excessive length unit that extends to an input side and an output side of the interaction unit and that is formed using the electro-optical polymer; and
an other waveguide that is not connected to the waveguide and that is formed by inserting a part of the excessive length unit into the slot located between a first doped layer that is connected to the ground electrode that is disposed parallel to the excessive length unit and a second doped layer that is connected to the signal electrode that is disposed parallel to the excessive length unit.

10. An optical communication apparatus comprising:
a processor that executes signal processing on an electrical signal;
a light source that emits light; and
an optical modulator that modulates the light emitted from the light source by using the electrical signal that is output from the processor, wherein
the optical modulator includes
a waveguide,
an electrode that has a coplanar structure and that includes a signal electrode and a ground electrode that are disposed parallel to the waveguide,
an interaction unit that is constituted such that a part of the interaction unit is inserted into a slot provided in the waveguide, that is formed using an electro-optical polymer, and that acts on light passing through the waveguide in accordance with a drive voltage of a highfrequency signal received from the electrode,
an excessive length unit that extends to an input side and an output side of the interaction unit and that is formed using the electro-optical polymer, and
an other waveguide that is not connected to the waveguide and that is formed by inserting a part of the excessive length unit into the slot located between a first doped layer that is connected to the ground electrode that is disposed parallel to the excessive length unit and a second doped layer that is connected to the signal electrode that is disposed parallel to the excessive length unit.
